(19) United States
(12) Patent Application Publication
(10) Pub. No.: US 2005/0037780 A1
(43) Pub. Date: Feb. 17, 2005

(54) MOBILE COMMUNICATION DEVICE WITH DIGITAL COMPASS

(76) Inventors: Sheng-Jung Kuo, Taipei City (TW); Sheng-Fang Cheng, Taipei City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/605,913

(22) Filed: Nov. 5, 2003

(30) Foreign Application Priority Data
Jul. 24, 2003 (TW) 092120175

(51) Int. Cl. H04Q 7/20

(52) U.S. Cl. 455/457; 455/566

(57) ABSTRACT

A mobile communication device includes a control unit, an output device, a memory, a digital compass, an input device, a microphone, and a speaker. These components are connected with a power source. The control unit calculates direction information with the program stored in the memory, and the direction information is transmitted from the digital compass to the output device. Even without knowledge of compass operation, a user can reference the mobile communication device displaying an accurate direction on the output device.

### BACKGROUND OF INVENTION

1. Field of the Invention

The present invention relates to a mobile communication device, and more particularly, to a mobile communication device with a digital compass or a magnetic sensor and tilt sensor which can calculate and determine direction information.

2. Description of the Prior Art

With the advent of wireless telecommunication technology, it is very convenient for a user to communicate with others by mobile communication devices, such as mobile phones. That is, the convenience of wireless communications devices has increased the mobility of people in modern times. Whether users are driving on the road or walking, they can communicate with others via mobile phones. In the prior art, mobile phones are well known, and are becoming increasingly popular in recent years.

Referring to FIG. 1, a conventional mobile phone has a housing 1, an antenna 2, a liquid crystal display 3, a keypad 4, a microphone 5, and a speaker 6. When the user wants to make a call, all they have to do is initiate the call thought the keypad 4, and then they can speak and listen through the microphone 5 and the speaker 6 respectively. However, when travelling or in unfamiliar territory, the user must typically carry additional instruments, such as a compass, in order to instantaneously determine direction or heading information. Furthermore, it is often additionally required by the user to have knowledge of using the compass. For a user, carrying around several multiple devices is particularly cumbersome when walking or driving. In an attempt to reduce costs, the conventional mobile phone must be configured with more useful features.

Thus, there is a need to develop a mobile communication device with a digital compass or a magnetic sensor and a tilt sensor.

### SUMMARY OF INVENTION

It is an object of the present invention to provide a mobile communication device with digital compass.

It is an object of the present invention to provide a mobile communication device with a magnetic sensor and a tilt sensor.

It is another object of the present invention to provide a mobile communication device capable of displaying direction information.

In order to accomplish the object of the present invention, the present invention includes a control unit, an output device, a memory, a digital compass, an input device, a microphone, and a speaker. These components are connected with a power source. In accordance with the present invention, the direction information is provided through the digital compass. The control unit takes and calculates the direction information from the digital compass and indicates an accurate direction. In this regard, even without knowledge of compass operation, a user can reference the mobile communication device displaying the accurate direction on the output device.

### BRIEF DESCRIPTION OF DRAWINGS

The present invention can be fully understood from the following detailed description and preferred embodiment with reference to the accompanying drawings in which:

FIG. 1 is a perspective view of a conventional mobile phone;

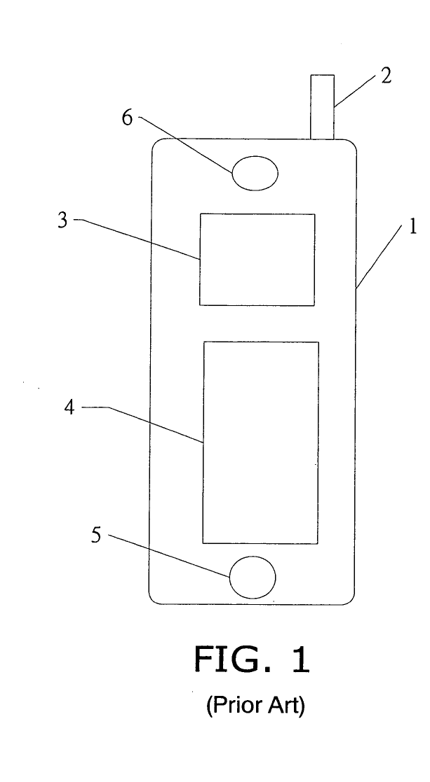

FIG. 2 is a block diagram of a mobile communication device in accordance with the first embodiment of the present invention; and

FIG. 3 is a block diagram of a mobile communication device in accordance with the second embodiment of the present invention.

### DETAILED DESCRIPTION

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

Although the embodiments of the present invention are described below in connection with mobile communication devices, the present invention can be applied to all hand-held or portable devices, including but not limited to mobile phones, wristwatches, GPS device, as well as all other portable devices or gadgets.

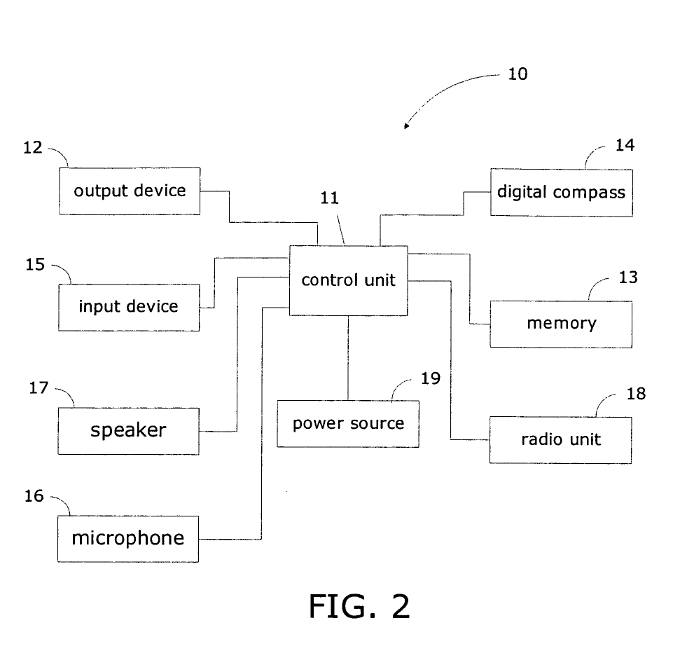

FIG. 2 illustrates a block diagram of a mobile communication device in accordance with the first embodiment of the present invention.

Referring to FIG. 2, a mobile communication device10 of the present invention includes a control unit 11, an output device 12, a memory 13, a digital compass 14, an input device 15, a microphone 16, a speaker 17, a radio unit 18, and a power source 19.

As shown in FIG. 2, the control unit 11 is connected to the output device 12 and the memory 13. The output device 12 can be a thin-film transistor (TFT) display or a plasma display. In accordance with this embodiment, the output device 12 of the mobile communication device 10 provides useful time information and compass information to the user, either individually or simultaneously. The memory 13 can store a program for calculating direction information, and the memory 13 can be a read-only memory (ROM).

Further referring to FIG. 2, the digital compass 14 is also connected to the control unit 11. The control unit 11 retrieves the program stored in the memory 13 and calculates the direction information via the program. Then, the control unit 11 sends the direction information to the digital compass 14. For instance, the digital compass 14 can convert the direction information from the control unit 11 into a direction of “North” and transmit this direction information to the output device 12. Thus, the direction of “North” can be displayed on the output device 12. In this regard, when the digital compass 14 of the mobile communication device10 is actuated, the control unit 11 calculates the direction information with the program storied in the memory 13, and the direction information is transmitted from the digital compass 14 to the output device 12. This feature is particularly useful for users who are walking or driving.

Furthermore, the radio unit 18 of the mobile communication device 10 in accordance with the present invention can be the same as the conventional radio unit performing processing related to transmitting/receiving call signals. The radio unit 18 is also connected with the control unit 11, and when the user transmits/receives a message through the mobile communication device 10, the radio unit 18 can execute modulation and demodulation of the call signals. The user can transmit/receive the phone call via a keypad (not shown) of the input device 15, and can transmit/receive audio signals via the speaker 17 and microphone 16. Furthermore, the power source 19 supplies power to the control unit 11, the output device 12, the memory 13, and other components requiring it.

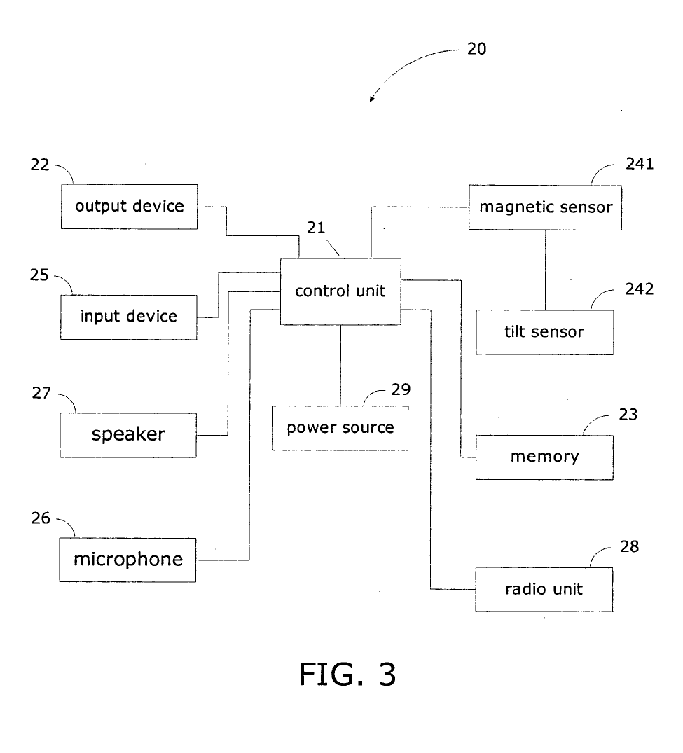

FIG. 3 illustrates a block diagram of a mobile communication device in accordance with the second embodiment of the present invention.

Referring to FIG. 3, a mobile communication device 20 of the present invention includes a control unit 21, an output device 22, a memory 23, a magnetic sensor 241, a tilt sensor 242, an input device 25, a microphone 26, a speaker 27, a radio unit 28, and a power source 29. The control unit 21, the output device 22, the memory 23, the input device 25, the microphone 26, thespeaker 27, the radio unit 28, and the power source 29 of the second embodiment can be the same as the control unit 11, the output device 12, the memory 13, the digital compass 14, the input device 15, the microphone 16, thespeaker 17, the radio unit 18, and the power source 19 of the first embodiment.

As shown in FIG. 3, the control unit 21 is connected to the output device 22 and the memory 23. The output device 22 can be a thin-film transistor (TFT) display or a plasma display. In accordance with this embodiment, the output device 22 of the mobile communication device 20 provides useful time information and compass information to the user, either individually or simultaneously. The memory 23 can store a program for calculating direction information, and the memory 23 can be a ROM.

Further referring to FIG. 3, the magnetic sensor 241 is connected to the control unit 21 and the tilt sensor 242. The magnetic sensor 241 can be a three-axis magnetic sensor and the tilt sensor 242 can be a two-axis tilt sensor. The control unit 21 retrieves the program stored in the memory 23 and calculates the direction information via the program. Then, the control unit 21 sends the direction information to the magnetic sensor 241. The magnetic sensor 241 can convert the strength of the Earths magnetic field in each of the x, y, and z directions at the location of the mobile communication device 20. In addition, the tilt sensor 242 can be used to measure the orientation of the mobile communication device 20 and send tilt information to the magnetic sensor 241. The direction information can be modified referencing to the tilt information before the magnetic sensor 241 converts the direction information from the control unit 21 into a direction, such as “North”, and transmits the direction information to the output device 22. Thus, the direction of “North” can be displayed on the output device 22. In this regard, when the magnetic sensor 241 of the mobile communication device 20 is actuated, the control unit 21 calculates the direction information with the program stored in the memory 23, and the direction information is transmitted from the magnetic sensor 241 to the output device 22. This feature is particularly useful for users who are walking or driving.

Furthermore, the radio unit 28 of the mobile communication device 20 in accordance with the present invention can be the same as the conventional radio unit performing processing related to transmitting/receiving call signals. The radio unit 28 is also connected with the control unit 21, and when the user transmits/receives a message through the mobile communication device 20, the radio unit 28 can execute modulation and demodulation of the call signals. The user can transmit/receive the phone call via a keypad (not shown) of the input device 25, and can transmit/receive audio signals via the speaker 27 and microphone 26. Furthermore, the power source 29 supplies power to the control unit 21, the output device 22, the memory 23, and other components requiring it.

As described above, the mobile communication device is equipped with a magnetic sensor or a digital compass and can provide time information and direction information to a user while walking or driving. Even if the user is not familiar with the layout of the city and has no knowledge of using compasses, they can easily determine the direction “North”.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

1. A mobile communication device for display direction information, comprising:
a control unit;
a memory, connected to the control unit and having a program for calculating the direction information;
an output display, connected to the control unit and; and
a digital compass, connected to the control unit and converting the direction information from the control unit;
wherein the control unit calculates the direction information by the program stored in the memory, and the direction information is transmitted by the digital compass to the output device.

2. The mobile communication device as claimed in claim 1, wherein the memory can be a read-only memory (ROM).

3. The mobile communication device as claimed in claim 1, wherein the output device can be a thin-film transistor (TFT) display or plasma display.

4. The mobile communication device as claimed in claim 1, further comprising an input device, a microphone, a speaker, a radio unit and a power source, and the control unit for controlling the input device, the microphone, the speaker and the power source.

5. A mobile communication device for display direction information, comprising:
a control unit;
a memory, connected to the control unit and having a program for calculating the direction information;
an output display, connected to the control unit and; and
a magnetic sensor, connected to the control unit and converting the strength of the Earths magnetic field; and
a tilt sensor, connected to the magnetic sensor and measuring the orientation and sending the orientation to the magnetic sensor;
wherein the control unit calculates the direction information by the program stored in the memory, and the direction information is transmitted by the magnetic sensor to the output device.

6. The mobile communication device as claimed in claim 5, wherein the memory can be a read-only memory (ROM).

7. The mobile communication device as claimed in claim 5, wherein the output device can be a thin-film transistor (TFT) display or plasma display.

8. The mobile communication device as claimed in claim 5, wherein the magnetic sensor can be called a three-axis magnetic sensor.

9. The mobile communication device as claimed in claim 5, wherein the tilt sensor can be called a two-axis tilt sensor.

10. The mobile communication device as claimed in claim 5, further comprising an input device, a microphone, a speaker, a radio unit and a power source, and the control unit for controlling the input device, the microphone, the speaker and the power source.
